(19) United States
(12) Patent Application Publication
(10) Pub. No.: US 2004/0085941 A1
(43) Pub. Date: May 6, 2004

(54) Information appliance control system

(76) Inventors: Pei-Zhi Li, Shanghai (CN); Dai-Shui Ho, Taipei Hsien (TW); Shih-Kuang Tsai, Taipei Hsien (TW); Wen-Jiang Qing, Shanghai (CN)

Correspondence Address: NAIPO (NORTH AMERICA INTERNATIONAL PATENT OFFICE), P.O. BOX 506, MERRIFIELD, VA, 22116, US

(21) Appl. No.: 10/065,653

(22) Filed: Nov. 6, 2002

(51) Int. Cl. H04Q 7/24

(52) U.S. Cl. 370/338

(57) ABSTRACT

An information appliance control system includes a console and a plurality of information appliances. The console includes a transmitter for wirelessly transmitting control signals for the plurality of information appliances. Each information appliance includes a receiver for receiving the control signals transmitted by the console to control operation of the information appliance.

### BACKGROUND OF INVENTION

1. Field of the Invention

The present invention relates to an information appliance control system, and more particularly, to an information appliance control system for controlling operations of information appliances using a Bluetooth protocol.

2. Description of the Prior Art

During the past decade, the dramatic development of communications technologies has changed people's lives. For example, people can work in an office and control operations of information appliances at home with a computer via the Internet.

Please refer to FIG. 1, which is a block diagram of an information appliance control system 10 according to the prior art. The control system 10 comprises a first computer 12, a second computer 14, an air conditioner 16, a television 18, and a video recorder 20. The air conditioner 16, the television 18, and the video recorder 20 are all information appliances. That is, the air conditioner 16, the television 18, and the video recorder 20 are all capable of receiving instructions transmitted by a computer and of operating according to the instructions. In FIG. 1, the first computer 12 transmits instructions for controlling operations of the information appliances 16, 18, and 20 to the second computer through the Internet 26. The first computer 12 is located, for example, at an office, and the second computer 14 is located at home. Of course, the information appliances 16, 18, and 20 are also located at home. As soon as the second computer 14 receives the instructions transmitted by the first computer 12 via the Internet 26, the second computer 14 transmits corresponding instructions to corresponding information appliances 16,18, and/or 20 via local area networks 22, 24 to control operations of the information appliances 16, 18, and 20.

Although it is very convenient to control operations of the information appliances 16, 18, and 20 through network systems (the Internet 26 and the local area networks 22, 24), to establish a wired network system is not an easy job. Furthermore, a complicated layout of the wired control system 10 usually restricts the information appliances from functioning normally. However, a wireless control system does not have these drawbacks.

Please refer to FIG. 2, which is a block diagram of another information appliance control system 30 according to the prior art. The control system 30 comprises a base station 32, a mobile phone 34, an air conditioner 36, a television 38, and a video recorder 40. The information appliances 36, 38, and 40 of the control system 30 are capable of receiving control signals transmitted by the mobile phone 32 via the base station 32 and of operating according to the control signals. In the control system 30, a user of the mobile phone 34 can transmit a control signal to control the video recorder 40 to record a TV program with the mobile phone 30 before the user returns home. Thus, the user can watch the TV program recorded by the video recorder 40 after the user has arrived home. In contrast to the wired control system 10, the wireless control system 30 is easy to set up and does not have any layout problems. However, the control signals transmitted by the mobile phone 34 are vulnerable to electromagnetic interference originating from other wireless communications devices inside or outside the control system 30. Furthermore, radio signals transmitted by other mobile phones may impact operations of the information appliances 36, 38, and 40 of the control system 30.

### SUMMARY OF INVENTION

It is therefore a primary objective of the claimed invention to provide an information appliance control system to overcome the above-mentioned drawbacks.

According to the claimed invention, the information appliance control system comprises a console having a transmitter for wirelessly transmitting control signals, and a plurality of information appliances, each information appliance comprising a receiver for receiving the control signals to control operations of the information appliance.

In the information appliance control system, the control signals transmitted by the console conforms to the IEEE 802.11b, and the console and the plurality of information appliances all use a Bluetooth protocol to send and receive the control signals.

It is an advantage of the claimed invention that an information appliance control system needs not to establish a complicated wired layout.

It is another advantage of the claimed invention that an information appliance control system controls operations of information appliances based on the Bluetooth protocol, so the control system can be immune from interferences caused by other radio signals. Additionally, because the control system adopts the Bluetooth protocol to control operations of information appliances, power consumption of the control system is very small.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a first information appliance control system according to the prior art.

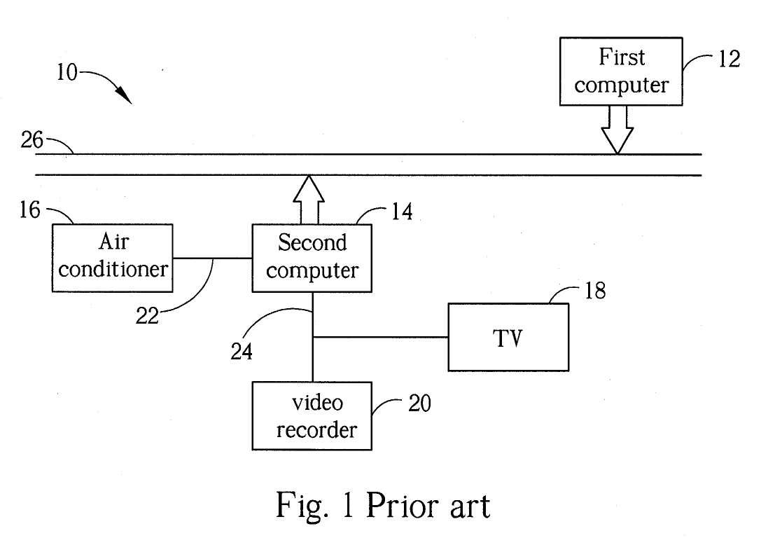

FIG. 2 is a block diagram of a second information appliance control system according to the prior art.

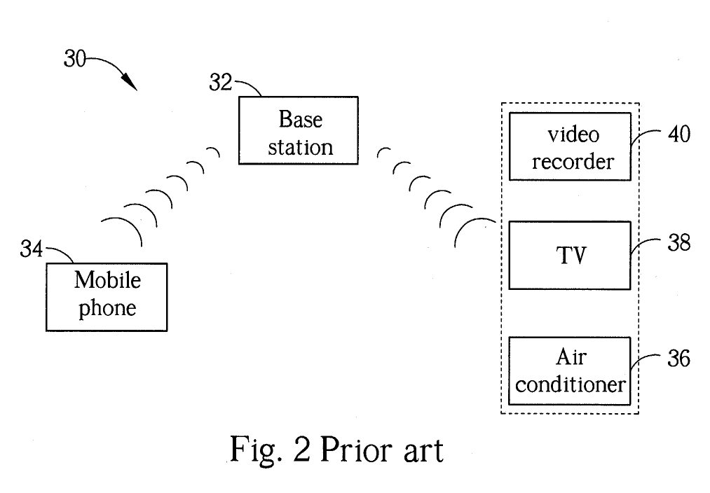

FIG. 3 is a schematic diagram of a piconet of a Bluetooth system according to the present invention.

FIG. 4 is a block diagram of an information appliance control system according to the present invention.

FIG. 5 is a function block diagram of a master device software system of the information appliance control system according to the present invention.

FIG. 6 is a function block diagram of a slave device software system of the information appliance control system according to the present invention.

### DETAILED DESCRIPTION

Ericsson, IBM, Intel, Nokia, and Toshiba established a Bluetooth communications protocol in 1995. The main objective of the Bluetooth protocol is to develop a unified radio frequency wireless transmission protocol to replace the existing short-distance signal transmission line and a part of wireless transmission channels in personal or in household systems. The Bluetooth protocol provides transmission channels for voice data or any other types of data.

A Bluetooth system has characteristics of short-distance transmission (usually less than 10 meters, sometimes up to 100 meters or down to 1 meter after being processed by appropriated power-controlling procedures) and low power-consumption (1 mW). The Bluetooth system also conforms to the IEEE 820.11b 2.45 Ghz standard, so the Bluetooth system is suited for an information appliance control system.

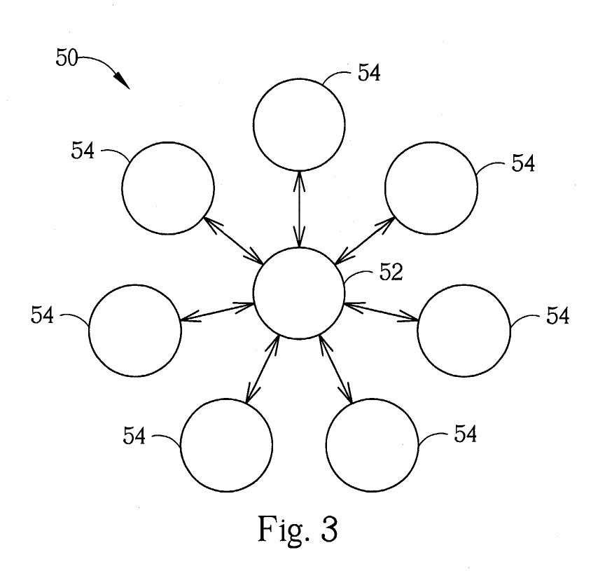

The Bluetooth system wirelessly connects a plurality of Bluetooth devices to form a piconet 50 in a point-to-point protocol (PPP), as shown in FIG. 3. In FIG. 3, the piconet 50 comprises a master device 52 and a plurality of slave devices 54. The master device 52 controls functionalities of the piconet 50. In a medium access control (MAC) layer of wireless communications systems, devices (master or slave) of a piconet are defined by only three bits. That is, the piconet 50 can only include eight devices—one master equiment and seven slave device. In reality, however, the piconet 50 can include more than eight devices. The fact is the Bluetooth system can enable only eight devices (one must be a master, and the others slaves) in a certain period of time.

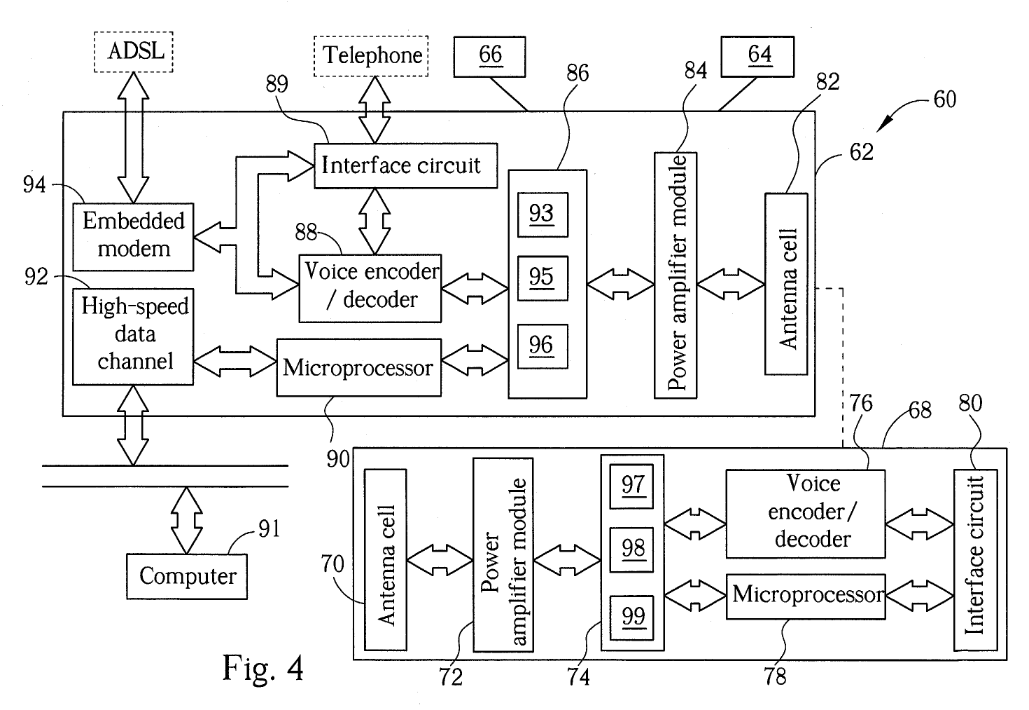

Please refer to FIG. 4, which is a block diagram of an information appliance control system 60 according to the present invention. The control system 60 comprises a console 62, an air conditioner 64, a television 66, and a video recorder 68. The console 62 acts as the master device 52 shown in FIG. 3, and the air conditioner 64, the television 66, and the video recorder 68 act as the slave devices 54 shown in FIG. 3. The console 62 comprises a transmitter for wirelessly transmitting control signals to control operations of the slave devices 64, 66, and 68. Each of the slave devices 64, 66, and 68 has a receiver for receiving the control signals transmitted by the transmitter of the console 62. The receiver for the television 66 and the air conditioner 64 are not shown in FIG. 4.

The receiver for the video recorder 68 comprises an antenna cell 70, a 2.45 Ghz power amplifier module 72 electrically connected to the antenna module 70, a Bluetooth module 74 electrically connected to the power amplifier module 72, a voice encoder/decoder 76 electrically connected to the Bluetooth module 74, an embedded microprocessor 78, and an interface circuit 80 electrically connected the voice encoder/decoder 76 and to the embedded microprocessor 78.

The transmitter of the master device (console) 62 comprises an antenna cell 82, a 2.45 Ghz power amplifier module 84 electrically connected to the antenna module 82, a Bluetooth module 86 electrically connected to the power amplifier module 84, a voice encoder/decoder 88 electrically connected to the Bluetooth module 86, an interface circuit 89 electrically connected to the voice encoder/decoder 88, an embedded microprocessor 90 connected to the Bluetooth module 86, a high-speed data channel 92 electrically connected to the microprocessor 90, and an embedded modem 94 electrically connected the voice encoder/decoder 88 and to the interface circuit 89.

The interface circuit 89 of the master device 62 is used to connect to a telephone and to receive control instructions transmitted by the telephone to control operations of the information appliances 64, 66, and 68. The high-speed data channel 92 of the master device 62 is used to connect to the Internet or to a local area network to receive control instructions transmitted by a computer 91 through the Internet or the local area network to control operations of the information appliances 64, 66, and 68. The embedded modem 94 is used to connect to an Asymmetric Digital Subscriber Line (ADSL) to accept control instructions transmitted from the ADSL to control operations of the information appliances 64, 66, and 68.

The antenna cell 82 of the master device 62 and the antenna cell 70 of the slave device 68 (because the slave device 68 is identical to the slave devices 64 and 66, only the slave device 68 will be described in following paragraphs) are microstrip antennas, so the volume of the antenna cells 82 and 70 is very small. The antenna cells 82 and 70 of the control system 60 adopt diverse techniques to overcome multi-path interferences. A working frequency of the power amplifier modules 84 and 72 is 2.45 Ghz and a frequency band of the power amplifier modules 84 and 72 lies from 2400 Mhz to 2483.5 Mhz. A valid communications range of the control system 60 is 10 meters or can be adjusted up to 100 meters or down to 1 meter by changing power of the radio signals transmitted by the control system 60.

The embedded microprocessor 90 of the master device 62 is designed to be embedded into the master device 62 for data transformation between different communications protocols, for data exchange with outer communications networks, and for managing operations of the slave devices 64, 66, and 68.

The Bluetooth modules 86 and 74 of the master device 62 and the slave device 68 are used to realize base band protocol transformation, and to integrate, encode, and modulate voice data transmitted by the voice encoders/decoders 88 and 76 and data transmitted by the microprocessors 90 and 78 and to transmit the processed data to the power amplifier modules 84 and 72. Finally, the master device 62 and the slave device 68 wirelessly transmit the amplified data generated by the power amplifier modules 84 and 72 with the antenna cells 82 and 80. The Bluetooth module 86 of the master device 62 comprises an RF cell 93, a base band cell 95, and a link manager (LM) 96. The slave device 68 also comprises an RF cell 97, a base band cell 98, and a link manager (LM) 99. The RF cells 93 and 97 are used to transmit and to receive RF signals. The base band cells 95 and 98 are used to hop the radio signals and to transmit Bluetooth data. The LMs 96 and 98 are used to establish and to disconnect a link.

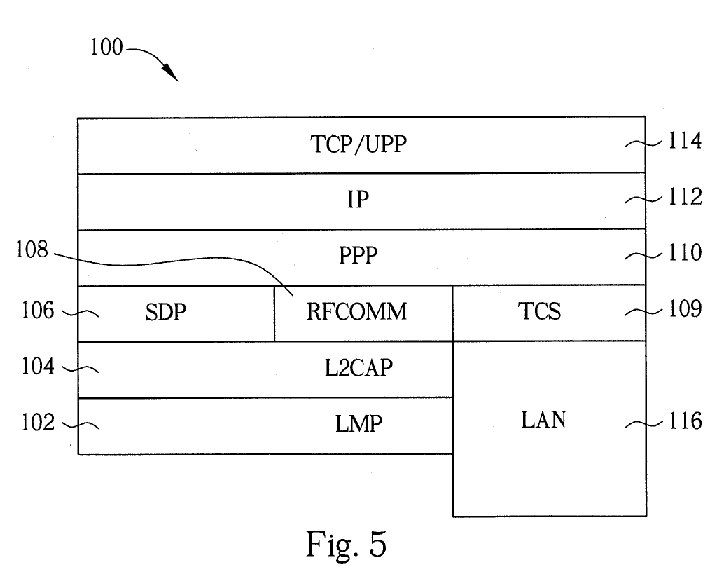

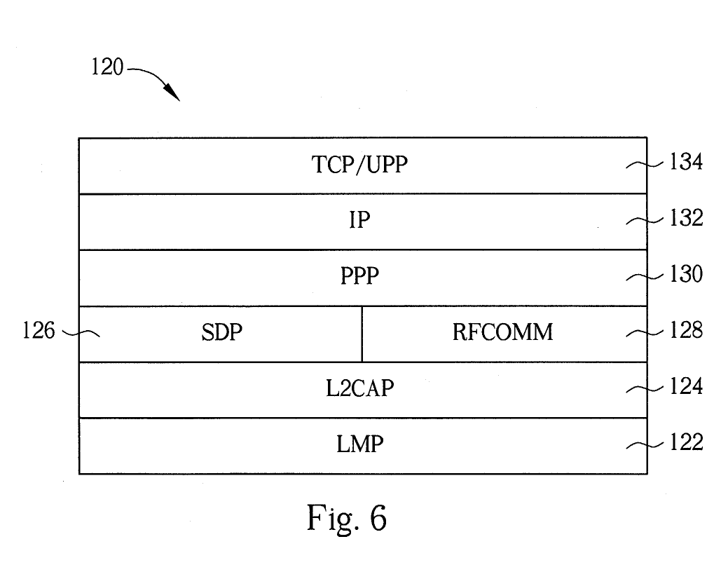

Software systems of the information appliance control system 60 are described as follows: The software systems of the control system 60 are all independent operation systems and conform to a Bluetooth protocol. The software systems manage data filtering and transmitting processes, frequency hopping and data frame transmitting processes, link connection establishing and abolishing processes, and link control in layer architectures. Please refer to FIG. 5 and FIG. 6. FIG. 5 is a function block diagram of a master device software system 100 of the control system 60. FIG. 6 is a function block diagram of a slave device software system 120 of the control system 60. Both the master device software system 100 and the slave device software system 120 comprise a lower layer protocol, a mid-layer protocol, and a higher layer protocol.

The lower layer protocol comprises a base band and link manager (LMP) 102 and 122 (the LMP 102 is included in the master device software system 100, and the LMP 122 in the slave device software system 120) for establishing physical links for a plurality of Bluetooth cells to form a piconet. The lower layer is further in charge of network securities, such as an encryption management.

The mid-layer protocol comprises a logical link control and adaptation protocol (L2CAP) 104 and 124 (likewise, the L2CAP 104 is included in the master device software system 100, and the L2CAP 124 in the slave device software system 120), a service discovery protocol (SDP) 106 and 126, an RFCOMM 108 and 128, a telephone control system (TCS) 109 (only existing in the master device software system 100), and a PPP protocol 110 and 130. The L2CAP 104 and 124 are used to accomplish integration between a base band and a higher layer protocol. The L2CAP 104 and 124 allow the higher layer protocol to transmit or receive an L2CAP packet of a length of 64,000 bytes. The SDP 106 and 126 are used to search available services on the Internet or a local area network and to identify characteristics of the available services. The TCS 109 comprises a TCS binary protocol and AT/commands. The TCS binary protocol defines call control signals for voice and data call in Bluetooth devices. The AT/commands are used to control commands output by a mobile phone or by a modem in a multi-user mode.

The higher layer protocol comprises an IP 112 and 132, a TCP/UDP 114 and 134, and a LAN 116(only existing in the master device software system 100). The master device 62 transfers an IP data packet to a local area network with the PPP 110 or transfers another IP data packet transmitted from the local area network to a PPP subscriber. The LAN 116 of the master device software system 100 is used to control the master device 62 to receive data of the local area network.

In contrast to the prior art information appliance control system 10, the present invention control system 60 needs not to establish a complicated wired layout. In contrast to the prior art information appliance control system 30, the present invention control system 60 controls operations of information appliances based on the Bluetooth protocol, so the control system 60 can be immune from interferences caused by other radio signals. Additionally, because the control system 60 adopts the Bluetooth protocol to control operations of information appliances, power consumption of the control system 60 is very small.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

What is claimed is:

1. An information appliance control system comprising:
a console having a transmitter for wirelessly transmitting control signals;
a plurality of information appliances, each information appliance comprising a receiver for receiving the control signals to control operations of the information appliance.

2. The information appliance control system of claim 1 wherein the control signals transmitted by the console conforms to the IEEE 802.11b.

3. The information appliance control system of claim 2 wherein the console and the plurality of information appliances all use a Bluetooth protocol to send and receive the control signals.
